(19) United States
(12) Patent Application Publication
(10) Pub. No.: US 2014/0219651 A1
(43) Pub. Date: Aug. 7, 2014

(54) Apparatus and Method for a Passive Optical Network

(71) Applicants: Stefano Ruffini, Rome (IT); Filippo Ponzini, Pisa (IT)

(72) Inventors: Stefano Ruffini, Rome (IT); Filippo Ponzini, Pisa (IT)

(73) Assignee: Telefonaktiebolaget L M Ericsson (publ), Stockholm (SE)

(21) Appl. No.: 14/130,893

(22) PCT Filed: Dec. 15, 2011
(86) PCT No.: PCT/EP2011/072951

§ 371 Date: Feb. 12, 2014

(30) Foreign Application Priority Data
Jul. 11, 2011 (EP) 111173418.2

(51) Int. Cl. H04B 10/25; H04J 14/02; H04B 10/077

(52) U.S. Cl. CPC H04B 10/2503; H04B 10/0775; H04J 14/0227
USPC 398/33

(57) ABSTRACT

A passive optical network comprises a first node configured to transmit a downlink data signal over a communication channel of an optical link, the communication channel having a first wavelength, and a second node configured to transmit an uplink data signal over the optical link using the communication channel having the first wavelength. The first node and/or the second node is adapted to perform at least one monitoring measurement on the communication channel having the first wavelength, and provide monitoring information, comprising the at least one monitoring measurement, in a monitoring channel. Common public radio interface (CPRI) traffic can therefore be transported over an optical transport network (OTN), by using a frequency reuse technique to provide a symmetrical bi-directional communication link between a first node and a second node, and using a frame structure of the optical transport network to provide a monitoring channel.

### TECHNICAL FIELD

The present invention relates to an apparatus and method for a Passive Optical Network, for example a Passive Optical Network employing Wave Division Multiplexing (WDM-PON), and in particular to an apparatus and method for performing monitoring functions (for example Operations, Administration and Maintenance monitoring functions), in a Passive Optical Network. The OAM monitoring functions may be configured to monitor the synchronization characteristics of timing critical signals (for example Common Public Radio Interface, CPRI signals).

### BACKGROUND

There are a number of applications in telecommunication networks that require accurate frequency and/or time synchronization references in order to operate properly, for example mobile technologies such as GSM, WCDMA and in the future LTE.

In the case of frequency synchronization the traditional solution is to obtain synchronization from a synchronous stream of data, for example as used in Time Division Multiplexing (TDM) based networks. However, the migration of networks from TDM to packet based technologies (such as Ethernet and Internet protocol) requires a different approach.

One solution is to use a packet based method, in which timing information is carried across a packet network (i.e. physical layer) by sending packets that contain timestamp information. The timestamps are generated by a master (server) that has access to an accurate reference, for example a Primary Reference Clock (PRC) that utilises GPS technologies.

FIG. 1 shows such a packet based method of distributing synchronization information. A timestamp master node 101 receives a PRC reference signal, for example based on GPS technology, and generates accurate timestamps which are sent in packets 103 over a packet network 105 to a receiving node 107. Each receiving node 107 comprises a processor 109 adapted to run an algorithm that recovers the timing information to produce a recovered reference timing signal 111, for example using adaptive clock recovery methods, such as comparing the local timing with the time information (timestamps) carried by the packets 103. Further information about the transport of timing information in packet networks can be found in the International Telecommunication Union's Telecommunication Standardization Sector (ITU-T) Recommendation G.8261, for example. This recommendation specifies the maximum network limits of jitter and wander that should not be exceeded in a network.

When time synchronization is requested, a two-way timing protocol is mandatory in applications such as Network Time Protocol (NTP) and Precision Time Protocol (PTP) where the transfer delay from master to slave is calculated.

One fundamental assumption with a two-way timing protocol approach is that the delay from master to slave and from slave to master shall be identical. This is because the mean path delay is calculated as half of the round trip delay. As a consequence, this has the disadvantage that any asymmetry in the network (that causes a different delay from master to slave compared to slave to master) will have a significant impact on the performance of the delivered time synchronization reference.

In some cases radio access can be implemented using an architecture where the radio control is separated from the remote radio access. This architecture can be based, for instance, on the Common Public Radio Interface (CPRI) Specification as illustrated in FIG. 2. This specification defines the key internal interfaces of radio base stations between a Radio Equipment Controller (REC) and a Radio Equipment (RE), further details of which can be found in the full CPRI Specification.

FIG. 2 shows a CPRI between two REs (RE#1 and RE#2). In addition to user plane data, synchronization signals as well as control and management signals have to be exchanged between the REC and REs. In particular, due to the time synchronization needs of the radio application, it is necessary to distribute over the CPRI link an accurate time reference, i.e. the CPRI channel must be symmetric and the short term phase noise must be controlled.

The following assumptions are made in the CPRI Specifications:
There is a point to point connection;
There is an ideal connection (e.g. no asymmetries), therefore minimal budget assigned to the CPRI;
Frequency synchronization: 50 parts per billion (ppb) on the radio interfaces;
Phase noise allocated to CPRI : 2 ppb rms (short term noise);
Long term: locked to the REC synchronization;
Time/Phase Synchronization: related to different needs;
There might be cases when there is no need for time/phase synchronization;
Various applications are considered. These can range from 1.5 microseconds to a few tens of nano seconds.

Time synchronisation is delivered from a Radio Equipment Controller (REC) to Radio Equipment (RE) via a 2-way exchange (similar to the IEEE1588 standard).

To support the most stringent applications a requirement is defined in the order of a few nano seconds. This is mainly related to internal measurement accuracy (and the assumption of an ideal connection).

Additional latency requirements are applicable in the case of CPRI in order to optimize the design of the REC (but this is not specified in the CPRI specification). The exact figure is not standardized but may be in the order of 100-200 microseconds (round trip delay).

The architecture shown in FIG. 2 and the related requirements are generating some concerns to telecom operators. For instance, when deploying a standard CPRI connection to connect a remote radio antenna unit (RRU), i.e. RE according to the CPRI terminology, or when deploying RRU to remote antennas by means of a CPRI-like connection, the following needs have been expressed:
deployment of a standardized transport which allows for Operations, Administration and Maintenance (OAM) functionality,
test points to be provided, for performance to be visible,
synchronization related parameters (which are important for CPRI) to be visible and monitored

Alongside the developments above, Optical Transport Networks (OTNs) are currently being considered (for example to provide CPRI over OTN), but due to the stringent synchronization requirements the existing OTN does not generally allow the stringent requirements mentioned above to be met.

In order to transport the CPRI over standardized transport technologies, one possible solution is to use new optimized OTN solutions with high timing accuracy, for example controlling asymmetries in the mapping and Forward Error Correction (FEC) process, and automatically compensating for asymmetries in the system that may be caused by the use of different fiber wavelengths and the use of different fiber lengths.

A disadvantage of such an approach is the significant upgrade required to OTN nodes, which increases complexity and cost. Furthermore, it is not clear whether such solutions provide the synchronization performance that is required.

### SUMMARY

It is an aim of the present invention to provide a method and apparatus which obviate or reduce at least one or more of the disadvantages mentioned above.

According to a first aspect of the present invention there is provided a method in a passive optical network. The method comprises the steps of using a particular wavelength for both an uplink transmission and a downlink transmission to provide a symmetrical bi-directional communication channel over an optical link. At least one monitoring measurement is performed in the symmetrical bi-directional communication channel. Monitoring information, comprising the at least one monitoring measurement, is provided in a monitoring channel of the passive optical network.

The invention has the advantage of enabling an accurate monitoring of synchronization to be performed. This is because the use of a particular wavelength for both the uplink and the downlink of an optical link (or optical fiber) ensure a symmetrical channel (hence not affecting mean time-delay calculations), while the provision of a monitoring channel enables performance measurements to be made visible to a user or operator.

According to another aspect of the invention there is provided a passive optical network comprising a first node configured to transmit a downlink data signal over a communication channel of an optical link, the communication channel having a first wavelength, and a second node configured to transmit an uplink data signal over the optical link using the communication channel having the first wavelength. The first node and/or the second node is adapted to perform at least one monitoring measurement on the communication channel having the first wavelength, and provide monitoring information, comprising the at least one monitoring measurement, in a monitoring channel.

According to another aspect of the present invention, there is provided a method of transporting common public radio interface (CPRI) traffic over an optical transport network (OTN). The method comprises the steps of using a frequency reuse technique to provide a symmetrical bi-directional communication link between a first node and a second node over an optical link, and using a frame structure of the optical transport network to provide a monitoring channel.

According to another aspect of the present invention, there is provided an optical network unit for a passive optical network. The optical network unit comprises a downlink optical receiver configured to receive a downlink data signal over a communication channel of an optical link, the communication channel having a first wavelength. The optical network unit also comprises an uplink optical transmitter configured to transmit an uplink data signal over the optical link using the communication channel having the first wavelength. A monitoring module is configured to perform at least one monitoring measurement on the communication channel having the first wavelength, and provide monitoring information, comprising the at least one monitoring measurement, in a monitoring channel.

### BRIEF DESCRIPTION OF THE DRAWINGS

For a better understanding of the present invention, and to show more clearly how it may be carried into effect, reference will now be made, by way of example only, to the following drawings in which:

FIG. 1 shows a packet based method of distributing synchronization information;

FIG. 2 shows a basic Common Public Radio Interface (CPRI) system architecture with a link between Radio Equipment (REs);

FIG. 3 shows the steps performed by a first embodiment of the present invention;

FIG. 4 shows a Passive Optical Network according to another embodiment of the present invention;

FIG. 5 shows how the embodiments of the invention may be used in a traditional CPRI application;

FIG. 6 shows how the embodiments of the invention may be used in an application having a connection from a remote radio antenna unit (RRU) to the remote antennas;

FIG. 7 shows an example of a wavelength reuse mechanism that may be used to enable the same wavelength to be used in the downlink and uplink of the embodiments of the invention;

FIG. 8 shows an example of how the monitoring channel may be provided, for example for carrying Operations, Administration and Management data in an Optical Transport Network (OTN) overhead, according to embodiments of the present invention; and

FIG. 9 shows an optical network unit for a passive optical network, according to an embodiment of the present invention.

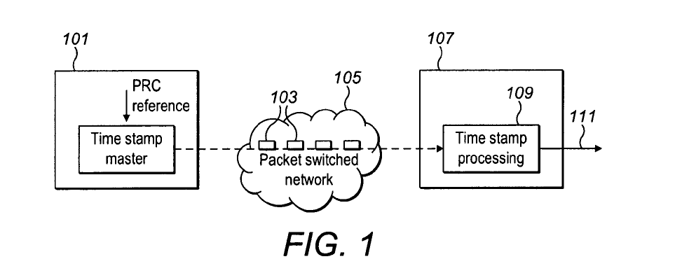

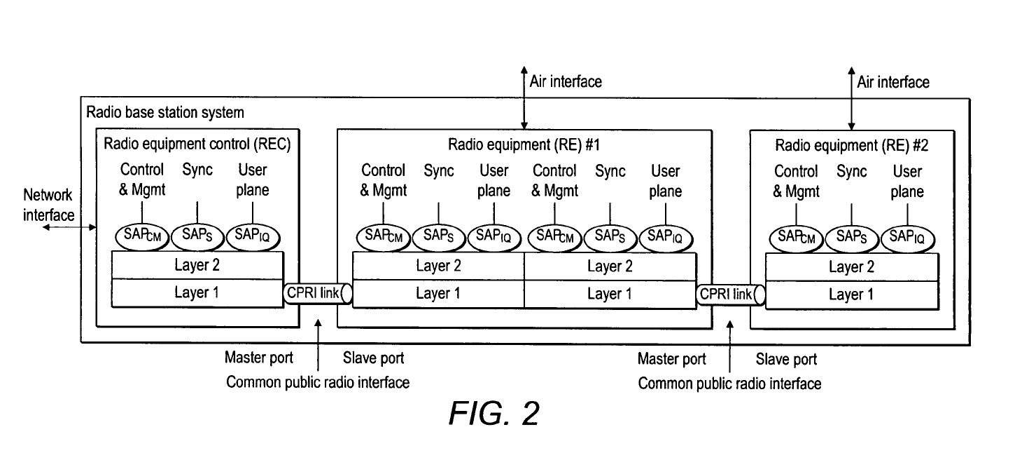

### DETAILED DESCRIPTION

The embodiments of the present invention relate to an apparatus and method for a Passive Optical Network, for example a Passive Optical Network employing Wave Division Multiplexing (WDM-PON). The embodiments are concerned with performing monitoring functions (for example Operations, Administration and Maintenance, OAM, monitoring functions) in a Passive Optical Network. The OAM monitoring functions may be configured to monitor the synchronization characteristics if timing critical signals (for example Common Public Radio Interface, CPRI, signals). It is noted, however, that other measurements are also intended to be embraced by the embodiments of the invention.

The various embodiments provide an enhanced point to point transport technique that is inherently accurate from a synchronization and asymmetry point of view. The provision of OAM and performance monitoring has advantages when timing critical services such as CPRI are being carried, as will be explained further below.

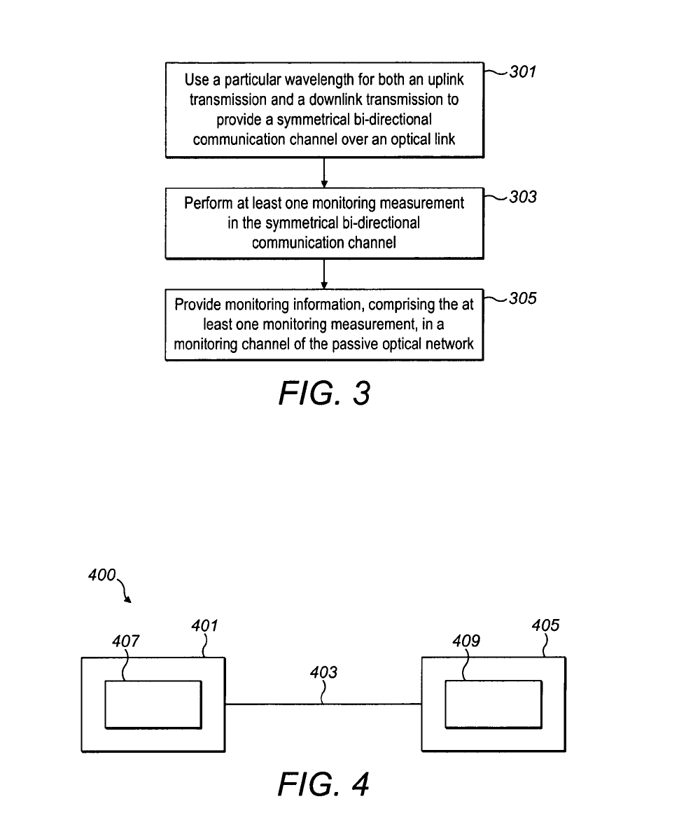

FIG. 3 shows a method according to a first embodiment of the present invention. In step 301 a particular wavelength is used for both an uplink transmission and a downlink transmission to provide a symmetrical bi-directional communication channel over an optical link. The optical link may comprise an optical fiber, or a plurality of optical fibers that couple together to form an optical link in a passive optical network. For example, in an application having a node such as a power or wavelength splitter provided along an optical link, or an optical regenerator, the optical fibers on either side of such a node can form an optical link. At least one monitoring measurement is performed in the symmetrical bi-directional communication channel, step 303. Monitoring information, comprising the at least one monitoring measurement, is provided in a monitoring channel of the passive optical network, step 305.

According to one embodiment the at least one monitoring measurement comprises a synchronization related measurement for determining the accuracy of synchronization, for example when using a precise measurement of one-way delay. It is noted, however, that the embodiments are intended to embrace other measurements being made, for example round trip delay.

The step of using a particular wavelength for both an uplink and a downlink transmission over the same optical link to build the bi-directional channel results in a symmetrical channel that enables the monitoring of the synchronization functions to be optimized.

FIG. 4 shows a passive optical network 400 according to another embodiment of the invention. The passive optical network 400 comprises a first node 401 configured to transmit a downlink data signal over a communication channel of an optical link 403, the communication channel having a first wavelength. A second node 405 is configured to transmit an uplink data signal over the optical link 403 using the communication channel having the first wavelength. The first node 401 and/or the second node 405 comprise a processor 407, 409 adapted to perform at least one monitoring measurement on the communication channel having the first wavelength, and provide monitoring information, comprising the at least one monitoring measurement, in a monitoring channel.

According to one embodiment, using the same optical link and same wavelength for bi-directional communication is accomplished using the techniques described by the present Applicant in patent application WO2010/025767, which is being incorporated herein by reference. It is noted, however, that the invention is intended to embrace other techniques for providing symmetrical bi-directional communication.

The use of a standard framing structure defined for OTN can also be used to simplify the implementation of embodiments of the invention, such as the provision of the monitoring channel.

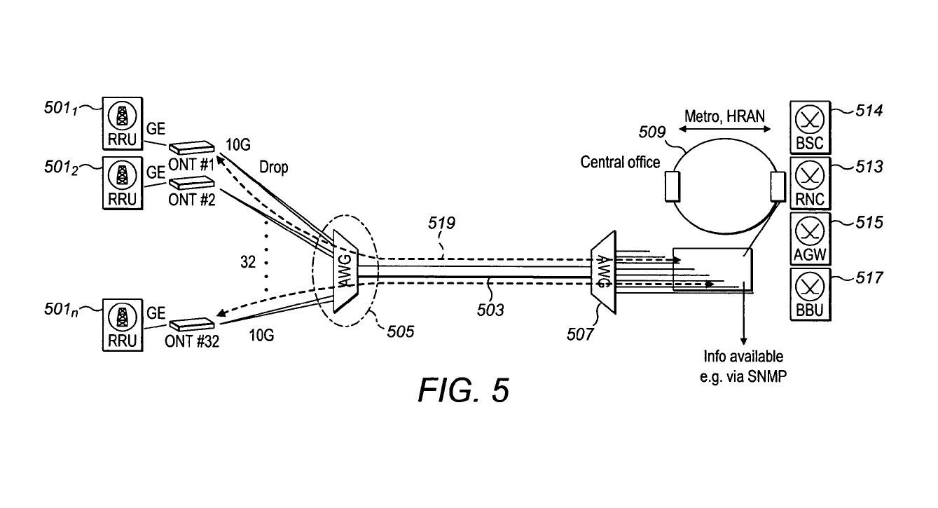

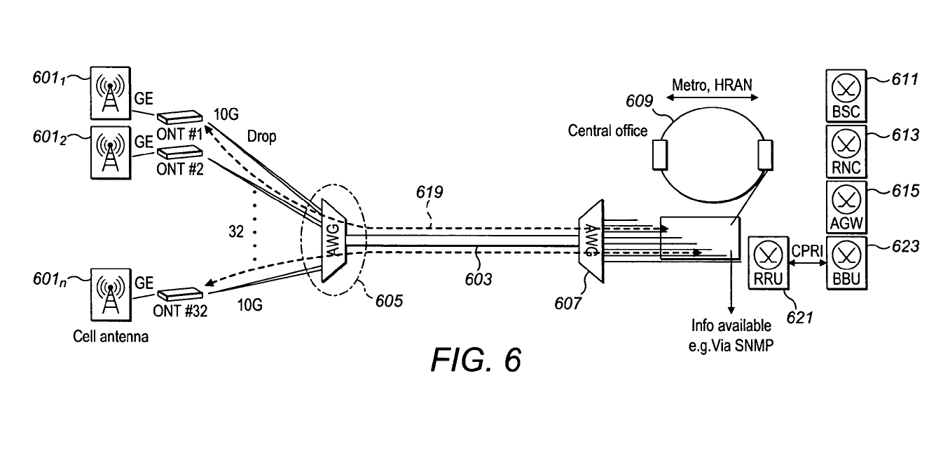

FIGS. 5 and 6 show examples of network architectures in which embodiments of the present invention may be used. FIG. 5 illustrates a traditional CPRI connection and FIG. 6 the connection from a remote radio antenna unit (RRU) to the remote antennas.

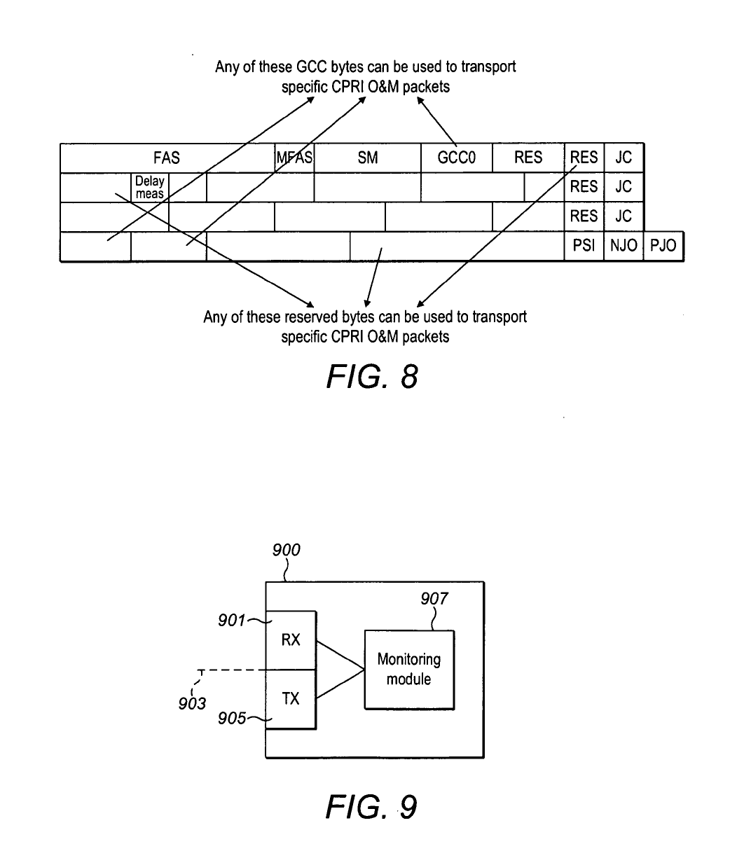

FIG. 5 is therefore based on a conventional architecture, but where there is an association of an OAM and monitoring channel 519 to the medium 503 used to carry each CPRI signal on both directions per antenna. A plurality of RRU's 501₁ to 501ₙ (for example 32 in the embodiment of FIG. 5) are shown as being connected to a remote node 505. The remote node 505 is configured to split out communication channels received over an optical link or feeder 503, for example using an arrayed waveguide grating (AWG). A node 507 (for example also comprising an AWG) is connected to a central office 509, which forms part of a high radio access network (HRAN) or metro network, comprising for example a base station controller (BSC) 511, radio network controller (RNC) 513, an arrayed waveguide grating (AWG) 515, and a battery backup unit (BBU) 517. The embodiments of the invention can be used in such an architecture, as mentioned in the Figures above, to specify how an OAM channel 519 (shown using the dotted line) can be optimized for the purpose of achieving a symmetric channel so that certain measurements can be performed. The monitoring channel (for example providing an Operations, Administration and Maintenance connection) can be embedded in a standard OTN framing architecture. For example, the OAM data can be carried over the overhead (as discussed below in relation to FIG. 8). The symmetric channel is obtained by using the same wavelength on the same optical link for bi-directional communication, as discussed above. The dedicated channel for monitoring can be used to provide information which includes, but which is not limited to, latency, jitter/wander measurements, frequency accuracy or alarms.

FIG. 6 illustrates how embodiments of the invention can be used with a different architecture. A plurality of cell antennas 601₁ to 601ₙ (for example 32 in the embodiment of FIG. 6) are shown as being connected to a remote node 605. The remote node 605 is configured to split out communication channels received over an optical link or feeder 603, for example using an arrayed waveguide grating (AWG). A node 607 (for example also comprising an AWG) is connected to a central office 609, which forms part of a high radio access network (HRAN) or metro network, comprising for example a base station controller (BSC) 611, radio network controller (RNC) 613, an arrayed waveguide grating (AWG) 615, and a RRU 621 connected to a battery backup unit (BBU) 623 via a CPRI interface. The embodiments of the invention can be used in such an architecture, as mentioned in the Figures above, to specify how an OAM channel 619 (shown using the dotted line) can be optimized for the purpose of achieving a symmetric channel so that certain measurements can be performed. The monitoring channel (for example providing an Operations, Administration and Maintenance connection) can be embedded in a standard OTN framing architecture. For example, the OAM data can be carried over the overhead (as discussed below in relation to FIG. 8). The symmetric channel is obtained by using the same wavelength on the same optical link, as discussed above. The dedicated channel for monitoring can be used to provide information which includes, but which is not limited to, latency, jitter/wander measurements, frequency accuracy or alarms.

Therefore, as shown in FIGS. 5 and 6 the channels can implement a bidirectional O&M connection. In this way it is possible to optimize the synchronization measurements. A round trip measurement (or a one-way measurement) would lead to an exact measurement of the delay between the RE and REC in the case of a CPRI application or in general for any master-slave communication, without any requirement to compensate for different wavelengths.

In general the following information could be sufficient and made available with the proposed approach, for monitoring the quality of the transport technology used for CPRI:
Latency and asymmetry (e.g. via two-way measurements and use of the Sellmeier equations to evaluate the actual delay applicable to the various wavelength actually used by the traffic channel)
Alarms
Jitter/wander measurements

As described in the following section this can be made possible by making use of the solution described in WO2010/025767, for example, and using a standardized framing option, for example the framing option for OTN, as described in Recommendation G.709. Other wavelength reuse mechanisms may also be used.

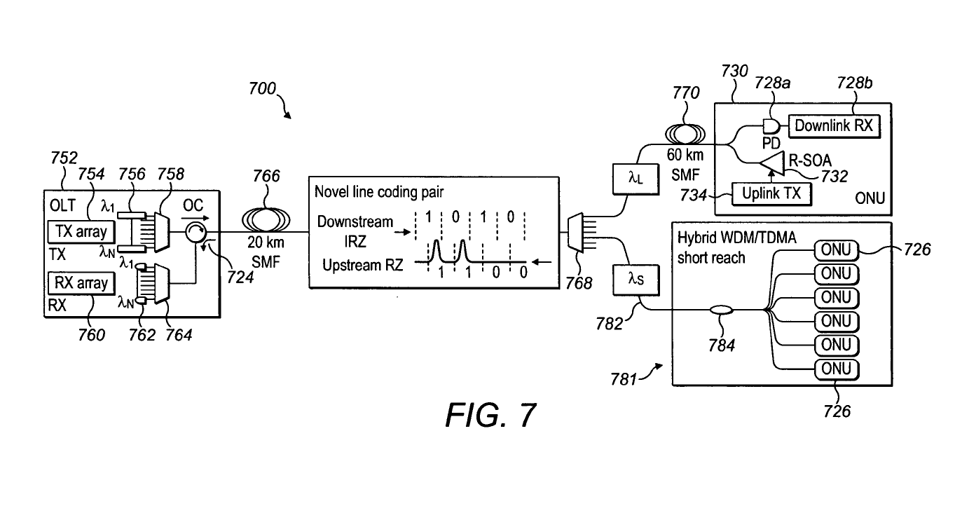

FIG. 7 is an example of a hybrid Wavelength Division Multiplexing (WDM)/Time Division Multiple Access (TDMA) Passive Optical Network (PON) 700, that may be used to provide symmetrical bi-directional communication. An Optical Line Termination (OLT) unit 752 comprises a downlink optical transmitter (Tx) array 754 configured to generate a plurality of inverse-return-to-zero (IRZ) line coded downstream data signals, each at a different one of a plurality of optical carrier wavelengths, and an uplink optical receiver (Rx) array 760 configured to receive a plurality of upstream data signals at said carrier wavelengths.

The downlink Tx array 754 comprises a plurality of optical carrier signal sources in the form of lasers 756. The resulting plurality of IRZ line coded downstream data signals are multiplexed through an arrayed waveguide grating (AWG) 758 and coupled via the optical circulator (OC) 724 into a single mode feeder fiber 766, having a length of 20 km, for example, which forms the first part of the optical link.

The uplink Rx array 760 comprises a corresponding plurality of photodiodes 762. Upstream data signals are coupled to the photodiodes 762 from the feeder fiber 766 through the circulator 724 and a demultiplexed in a second AWG 764. The WDM-PON 700 comprises an Optical Network Unit (ONU) 730. The optical link in this embodiment comprises the single mode feeder fiber 766, a distribution fiber 770 and a third AWG 768 coupled between the feeder fiber 766 and the distribution fiber 770. In this example, the distribution fiber is a long reach distribution fiber having a length of 60 km, for example. The third AWG 768 acts to demultiplex the plurality of downstream data signals and route each to their respective distribution fiber 770 and ONU 26, or fiber 782 and short reach TDMA sub-network 781.

The ONU 726 comprises a downlink optical receiver 728 (comprising a photodiode 728a and a digital receiver 728b) configured to receive a first portion of a downstream data signal, and an uplink optical remodulator configured to receive a second portion of the downstream data signal and to both remodulate and amplify it to generate a return-to-zero (RZ) line coded upstream data signal. The ONU 726 further comprises a local clock signal source (not shown) associated with the downstream receiver 728.

The uplink optical remodulator comprises an electro-optic modulator in the form of a reflective semiconductor optical amplifier (R-SOA) 732, an RZ electronic data signal source 734. The R-SOA 732 in this example comprises a commercially available device providing 21 dB of small signal gain at 50 mA bias current, 2 dBm output saturation power, 1 dB polarization dependent gain and 8 db noise figure, and is biased at 70 mA. The R-SOA 732 is operated outside of its saturation regime. The seed signal received at the R-SOA 732 has a power level of not greater than P=G−15 P(max), where P is in dBm, G is the gain of the R-SOA in dB, and P(max) is the maximum optical output power of the R-SOA in dBm. In this example, the seed signal has a power of between −15 dBm and −35 dBm. The RZ data signal source generates a 7V peak-to-peak 1.25 Gb/s RZ data signal. An optical delay line (not shown) coupled to the output of the R-SOA 732 acts to synchronize the upstream data signal (i.e. the RZ data signal) with the downstream data signal, in conjunction with the local clock source, so that the upstream data signal is interleaved by one-half bit with respect to the incoming downstream data signal. This means that the RZ data signal is applied (i.e. the R-SOA remodulates and amplifies) only when the seed signal comprises a CW signal, as follows.

When the downstream data signal, comprises a dark pulse (a logical 1), the seed signal comprises the dark pulse tail, which is suppressed by the R-SOA 732 to form a logical 0 for the upstream data signal or is amplified by the R-SOA 732 to form a logical 1. When the downstream data signal comprises a light pulse (a logical 0), the seed signal comprises a CW light pulse having a duration equal to the full 30 clock cycle, one-half of the light pulse is suppressed by the R-SOA 732 to form a logical 1 or the whole pulse is suppressed by the R-SOA 732 to form a logical 0.

The third AWG 768 acts to multiplex a plurality of upstream data signals received from the ONU 726 or short reach TDMA sub-network 781 into the feeder fiber 766 for transmission upstream to the OLT 752.

One or more of the carrier signal wavelengths is used for a short reach TDMA sub-network 781 from the third AWG 768 (only 1, As, is shown for clarity). The TDMA sub-network 781 comprises a short reach distribution fiber 782, a 1×N (in this example 1×6) optical power splitter 784 and six ONUs 726.

Although FIG. 7 shows one example of how frequency reuse can be implemented to enable bi-directional communication using the same wavelength, to therefore provide a symmetrical channel, it is noted that other configurations and arrangements may also be used to enable the same wavelength to be used on both an uplink and a downlink, according to embodiments of the present invention.

In order to provide round trip measurements with precision of a few nano seconds, preferably, a free running oscillator having an accuracy of at least 5 ppm, for example, or a frequency locked oscillator are provided at the ONT.

The particular embodiment of FIG. 7 consists in the use of the inverse-return-to-zero (IRZ) coding in a common reflective bidirectional WDM-PON. By using 50% IRZ coding in the downstream and return-to-zero (RZ) coding in the upstream signal, it is possible not only to achieve symmetrical bandwidth, but also to operate the reflective semiconductor optical amplifiers (R-SOAs, 732) far from the saturation regime, thus relaxing the constraints on the ONU's 730 received power. By using this technique it is possible to provide error-free full downstream re-modulation by seeding the R-SOA 732 with power levels as low as −35 dBm.

According to one embodiment, the monitoring channel (for example providing an Operations, Administration and Maintenance connection) is embedded in a standard OTN framing architecture. For example, the OAM data can be carried over the overhead. FIG. 8 illustrates various examples of where the OAM information can be provided. For example, any of the GCC bytes can be used to transport specific CPRI OAM packets. Any of the reserved bytes can also be used to transport specific CPRI OAM packets. A monitoring measurement, for example relating to assessing the synchronization parameters in the passive optical network, can then be made available in the monitoring channel.

It is noted that a Delay Measurement of a round trip delay could also make use of the predefined bits in the ODUk PM delay measurement (DMp) as per ITI-T recommendation G.709, for example.

By making the measurement on the same optical link, and using the same wavelength, this ensures that an accurate one-way delay measurement is obtained.

FIG. 9 shows an optical network unit 900 for a passive optical network, according to another embodiment of the present invention. The optical network unit 900 comprises a downlink optical receiver 901 configured to receive a downlink data signal over a communication channel of an optical link 903, the communication channel having a first wavelength. The optical network unit also comprises an uplink optical transmitter 905 configured to transmit an uplink data signal over the optical link 903 using the communication channel having the first wavelength. A monitoring module 907 is configured to perform at least one monitoring measurement on the communication channel having the first wavelength, and provide monitoring information, comprising the at least one monitoring measurement, in a monitoring channel. The optical network unit 900 may be configured to provide downlink and uplink communication using the same wavelength and over the same optical link using one of the techniques described above.

The embodiments described above can be optimized further, if desired, in order to control the possible asymmetries due to mapping and FEC in the two directions. This can be done by the OLT and ONU, for example, by monitoring a buffer position in the OLT and communicating this information to the ONU so that it can compensate for possible differences between the two mapping logic.

An advantage of the proposed method is that WDM PON is enhanced with OAM functionality and a monitoring channel, which are especially important when timing critical services such as CPRI are carried.

A dedicated monitoring channel per ONT allows resources to be optimized and measurements to be simplified. This is made possible by using the same lambdas (wavelength) in the upstream and downstream, and/or using the same cable/optical link used for traffic. Due to this it is possible to achieve accurate latency and asymmetry measurements.

The use of the same optical link also allows for optimized use of the resources, and the use of the same wavelength allows for a fully symmetric channel which is required in order to monitor some critical synchronization parameters.

It is noted that embodiments of the invention utilise a combination of a wavelength reuse mechanism and a standard framing structure of OTN, for example, such that the wavelength reuse allows a symmetrical channel, which enables an accurate path delay to be determined, while the structure of OTN enables OAM information to be conveyed.

The embodiments of the invention also have the advantage of allowing OAM functions to be managed from a central office. This is because the embodiments provide an additional monitoring capability that allows data to be collected, that eventually may be collected and analysed in a central location.

The embodiments of the invention enable common public radio interface (CPRI) traffic to be transported over an optical transport network (OTN), by sing a frequency reuse technique to provide a symmetrical bi-directional communication link between a first node and a second node, and using a frame structure of the optical transport network to provide a monitoring channel.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method in a passive optical network, the method comprising the steps of:
using a particular wavelength for both an uplink transmission and a downlink transmission to provide a symmetrical bi-directional communication channel over an optical link;
performing at least one monitoring measurement in the symmetrical bi-directional communication channel; and
providing monitoring information, comprising the at least one monitoring measurement, in a monitoring channel of the passive optical network.

2. A method as claimed in claim 1, wherein the step of using the particular wavelength for an uplink transmission and a downlink transmission to provide the symmetrical bi-directional communication channel over the optical link comprises the steps of:
coding a downlink data signal using an inverse-return-to-zero (IRZ) coding scheme; and
coding an uplink data signal using a return-to-zero (RZ) coding scheme.

3. A method as claimed in claim 1, wherein the step of providing a the monitoring channel comprises the step of using a framing structure of the passive optical network to carry the monitoring channel.

4. A method as claimed in claim 3, wherein the monitoring channel is provided in one or more overhead bytes of an optical transport network.

5. A method as claimed in claim 1, wherein the at least one measurement relates to a one-way delay or a round trip delay measurement of the symmetrical bi-directional communication channel.

6. A method as claimed in claim 1, wherein the at least one measurement relates to a synchronisation measurement in the symmetrical bi-directional communication channel.

7. A method as claimed in claim 1, wherein the monitoring information relates to an operations, administration and monitoring (OAM) information of a communication system.

8. A method as claimed in claim 1, wherein the passive optical network is configured to perform wavelength division multiplexing (WDM-PON).

9. A method of enhancing a point to point transport technique in a wave division multiplexing passive optical network (WDM PON), with specialized operations, administration and maintenance (OAM) operations, and/or performance monitoring, the method comprising the steps:
using a particular wavelength for both an uplink transmission and a downlink transmission to provide a symmetrical bi-directional communication channel over an optical link;
performing at least one monitoring measurement in the symmetrical bi-directional communication channel; and
providing monitoring information, comprising the at least one monitoring measurement, in a monitoring channel of the WDM PON.

10. A method of transporting common public radio interface (CPRI) traffic over an optical transport network (OTN), the method comprising the steps of:
using a frequency reuse technique to provide a symmetrical bi-directional communication link between a first node and a second node over an optical link; and
using a frame structure of the optical transport network to provide a monitoring channel.

11. A method as claimed in claim 10, wherein the monitoring channel comprises information relating to operations, administration and maintenance (OAM) information.

12. A passive optical network comprising:
a first node configured to transmit a downlink data signal over a communication channel of an optical link, the communication channel having a first wavelength;
a second node configured to transmit an uplink data signal over the optical link using the communication channel having the first wavelength;
wherein at least one of the first node and the second node is adapted to perform at least one monitoring measurement on the communication channel having the first wavelength, and provide monitoring information, comprising the at least one monitoring measurement, in a monitoring channel.

13. A passive optical network as claimed in claim 12, wherein the first node is adapted to code the downlink data signal using an inverse-return-to-zero (IRZ) coding scheme, and code the uplink data signal using a return-to-zero (RZ) coding scheme.

14. A passive optical network as claimed in claim 12, wherein the monitoring channel is provided in a framing structure of the passive optical network.

15. A passive optical network as claimed in claim 14, wherein the monitoring channel is provided in one or more overhead bytes of an optical transport network.

16. A passive optical network as claimed in claim 12, wherein the at least one measurement relates to a one-way delay or a round trip delay measurement of the communication channel having a first wavelength.

17. A passive optical network as claimed in claim 12, wherein the monitoring information relates to an operations, administration and monitoring (OAM) information of a communication channel.

18. A passive optical network as claimed in claim 12, wherein the passive optical network is a wavelength division multiplexing passive optical network (WDM-PON).

19. A central office node of a passive optical network, the central office node being adapted to perform the method comprising:
using a particular wavelength for both an uplink transmission and a downlink transmission to provide a symmetrical bi-directional communication channel over an optical link;
performing at least one monitoring measurement in the symmetrical bi-directional communication channel; and
providing monitoring information, comprising the at least one monitoring measurement, in a monitoring channel of the passive optical network.

20. An optical network unit for a passive optical network, the optical network unit comprising:
a downlink optical receiver configured to receive a downlink data signal over a communication channel of an optical link, the communication channel having a first wavelength;
an uplink optical transmitter configured to transmit an uplink data signal over the optical link using the communication channel having the first wavelength; and
a monitoring module configured to perform at least one monitoring measurement on the communication channel having the first wavelength, and provide monitoring information, comprising the at least one monitoring measurement, in a monitoring channel.
